(19) United States
(12) Patent Application Publication
(10) Pub. No.: US 2026/0233969 A1
(43) Pub. Date: Aug. 13, 2026

(54) EVALUATION OF A CONDITION OF AN AUTOMATIC DOOR DRIVE BELT

(71) Applicant: KONE CORPORATION, Helsinki (FI)

(72) Inventors: Matti Lin, Helsinki (FI); Petri Kuisma, Helsinki (FI)

(73) Assignee: KONE CORPORATION, Helsinki (FI)

(21) Appl. No.: 19/465,718

(22) Filed: Jan. 30, 2026

(30) Foreign Application Priority Data
Feb. 7, 2025 (EP) 25156518.0

(51) Int. Cl. B66B 5/00; B66B 13/08; B66B 13/14; B66B 13/30

(52) U.S. Cl. CPC B66B 5/0025; B66B 13/08; B66B 13/143; B66B 13/30

(57) ABSTRACT

A method for evaluating a condition of a door drive belt (250) of an automatic door (200) is provided, the method comprises: receiving (410) data descriptive of a movement of the automatic door (200) in response to a reduction of a driving force of the door motor (220) at an extreme position of the automatic door (200) in its travel path; comparing (420) at least part of the data descriptive of the movement of the automatic door (200) to reference data, and setting (430) a detection result to express one of the following: i) the condition of the door drive belt (250) is proper, ii) the condition of the door drive belt (250) is improper. Also a computing system (210, 280), an automatic door (200) and a computer program are provided to.

### TECHNICAL FIELD

The invention concerns in general the technical field of automatic doors, such as elevator doors. More particularly, the invention concerns a condition evaluation of a door drive belt.

### BACKGROUND

There are various types of automatic sliding doors that are operated by sliding at least one leaf of the automatic door in its travel path either to open a doorway to enable individuals to pass it or to close the doorway with the at least one leaf to prevent access through the doorway. FIGS. 1A-2F provide some non-limiting examples of possible implementations of automatic sliding doors. The illustrated types of the automatic doors are the following:

FIGS. 1A and 1B: The automatic door system comprises one door leaf 110 that is driven to close the doorway and open it for access. FIG. 1A provides a side-view of the automatic door and FIG. 1B a top-view of the same in a situation that the doorway is open.

FIGS. 1C and 1D: The automatic door system comprises two door leaves 110 that are driven to close the doorway and open it for access. The movement of the door leaves 110 may be synchronized by means of some sync mechanism, such as a synchronization rope, in a known manner. FIG. 1C provides a side-view of the automatic door and FIG. 1D provides a top-view of the same in a situation that the doorway is closed.

FIGS. 1E and 1F: The automatic door system comprises two door leaves 110 that are driven to close the doorway and open it for access. The door leaves 110 are arranged on the different sides of the doorway when the doorway is open and the door leaves 110 meet within the doorway area when the doorway is closed. FIG. 1E provides a side-view of the automatic door when the doorway is open for access and FIG. 1F provides a top-view of the automatic door in a situation that the doorway is closed.

As said, the door solutions depicted in FIGS. 1A-1E are non-limiting examples and e.g. the number of door leaves may vary a lot. The automatic door may e.g. comprise altogether six door leaves three on each side so that the door open in the middle. Another further example may be an automatic door consisting of three door leaves so that it opens from the side of the doorway.

In FIGS. 1A-1F a door frame is denoted with a reference 120 which defines limits of the door movement in at least one direction. In other words, the door frame 120 provides at least one surface, like wall, against which the door leaf 110, or door leaves 110, may be driven in at least one of the states (cf. open state/closed state). It is worthwhile to mention that in the implementation of the automatic door as shown in FIGS. 1E and 1F it may be considered that the door leaves 110 form a portion of the door frame 120 to each other when the doorway is closed by the door leaves 110, i.e. when the door leaves 110 meet in the doorway area.

In addition to the examples provided in FIGS. 1A-1F the automatic door may be established with a plurality of door leaves 110 arranged to travel parallel to each other for managing the access of the doorway. An example of such an implementation may be elevator door wherein one or more door leaves 110 may be arranged to operate as landing door(s) whereas other one or more door leaves 110 may be arranged to operate as elevator car doors. The movement of the parallelly operating door leaves 110 may be arranged to be synchronized e.g. by applying a door coupler in a known manner. In other words, the elevator car door may comprise coupler vanes which engage with coupler rollers mounted to the landing door. When a door motor initiates a movement to open the doors, the coupler vanes first move the coupler rollers such that the landing door lock opens. After that the car door and the landing door start open in a coupled mode until the doors are fully open.

An automatic door mechanism, e.g. applied in elevator doors, consists of various entities to operate the automatic door. As already mentioned, the automatic door comprises at least one leaf, or a door panel, that is moved by controlling an electric motor configured to generate a driving force to the at least one leaf. More specifically, an automatic door drive belt is arranged between two pulleys, usually called as a drive pulley and an idler pulley, wherein the electric motor is arranged to cause a force to rotate the drive pulley and thus the elevator door drive belt is linearly driven in a circular path. When the at least one leaf is secured to the elevator door drive belt with fixing means, like clamps or fasteners, the movement of the at least one door leaf is achieved by controlling the electric motor to drive the belt. As a result, the automatic door may be moved between the extreme positions in its travel path.

A tension of the automatic door drive belt is aimed to be kept optimal, i.e. it shall not be too tight or loose. Since the elevator door drive belt is a wearing component it gets loose over time and the loose belt tension may cause functional failure of automatic door. It may also have effect in ride comfort of the door, causing higher noise levels that may concern passengers.

In view of above there is a need to introduce solutions to monitor the tension of the door drive belt to prevent functional failure of the automatic door.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a computing system, an automatic door and a computer program for evaluating a condition of a door drive belt of an automatic door.

The objects of the invention are reached by a method, a computing system, an automatic door and a computer program as defined by the respective independent claims.

According to a first aspect, a method for evaluating a condition of a door drive belt of an automatic door is provided, wherein the automatic door is operated by controlling a door motor operatively coupled to a door leaf over the door drive belt, the method, performed by a computing system, comprises:

receiving data descriptive of a movement of the automatic door in response to a reduction of a driving force of the door motor at an extreme position of the automatic door in its travel path,

comparing at least part of the data descriptive of the movement of the automatic door to reference data, and

setting, in accordance with a comparison between the at least part of the data descriptive of the movement of the automatic door and the reference data, a detection result to express one of the following: i) the condition of the door drive belt is proper, ii) the condition of the door drive belt is improper.

The data descriptive of the movement of the automatic door may e.g. be received from an encoder of the door motor.

The reference data may be descriptive of at least one of the following: speed related limit; time related limit; a shape of a curve representing the movement of the automatic door.

The method may further comprise:

generating a request to maintain the door drive belt in response to that the condition of the door drive belt is set to be not proper.

According to a second aspect, a computing system for evaluating a condition of a door drive belt of an automatic door is provided, wherein the automatic

door is operated by controlling a door motor operatively coupled to a door leaf over the door drive belt, the computing system is configured to:

receive data descriptive of a movement of the automatic door in response to a reduction of a driving force of the door motor at an extreme position of the automatic door in its travel path,

compare at least part of the data descriptive of the movement of the automatic door to reference data, and

set, in accordance with a comparison between the at least part of the data descriptive of the movement of the automatic door and the reference data, a detection result to express one of the following: i) the condition of the door drive belt is proper, ii) the condition of the door drive belt is improper.

The computing system may be configured to receive the data descriptive of the movement of the automatic door from an encoder of the door motor.

For example, the computing system may be configured to apply as the reference data that is descriptive of at least one of the following: speed related limit; time related limit; a shape of a curve representing the movement of the automatic door.

The computing system may further be configured to:

generate a request to maintain the door drive belt in response to that the condition of the door drive belt is set to be not proper.

According to a third aspect, an automatic door is provided, the automatic door comprising:

at least one door leaf,

a door frame defining a travel path of the at least one door leaf, and

a computing system according to the second aspect as defined above.

The automatic door may further comprise at least one elastic element mounted between the door frame and the at least one door leaf. The at least one elastic element may be mounted to one of the following: the door frame; the at least one door leaf. For example, the at least one elastic element may have an elasticity allowing a squeeze of the elastic element in response to driving the at least one door leaf against the door frame. Still further, the at least one elastic element may be at least one of the following: a spring; a rubber piece; an air filled element.

The automatic door may be an elevator door.

According to a fourth aspect, a computer program is provided, the computer program comprising instructions to cause the computing system according to the second aspect as defined above to execute the steps of the method according to the first aspect as defined above.

The expression "a number of” refers herein to any positive integer starting from one, e.g. to one, two, or three.

The expression "a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIGS. 1A-1F illustrate schematically examples of automatic doors according to prior art.

FIG. 2 illustrates schematically an example of an automatic door according to an example.

FIGS. 3A and 3B illustrate schematically aspects in relation to a tension of a door drive belt according to an example.

FIG. 4 illustrates schematically a method according to an example.

FIG. 5 illustrates schematically curves relating to a movement of an automatic door according to an example.

FIG. 6 illustrates schematically aspects in relation to a detection of a condition of the door drive belt according to a first example.

FIG. 7 illustrates schematically aspects in relation to a detection of a condition of the door drive belt according to a second example.

FIG. 8 illustrates schematically an example of a computing system according to an example.

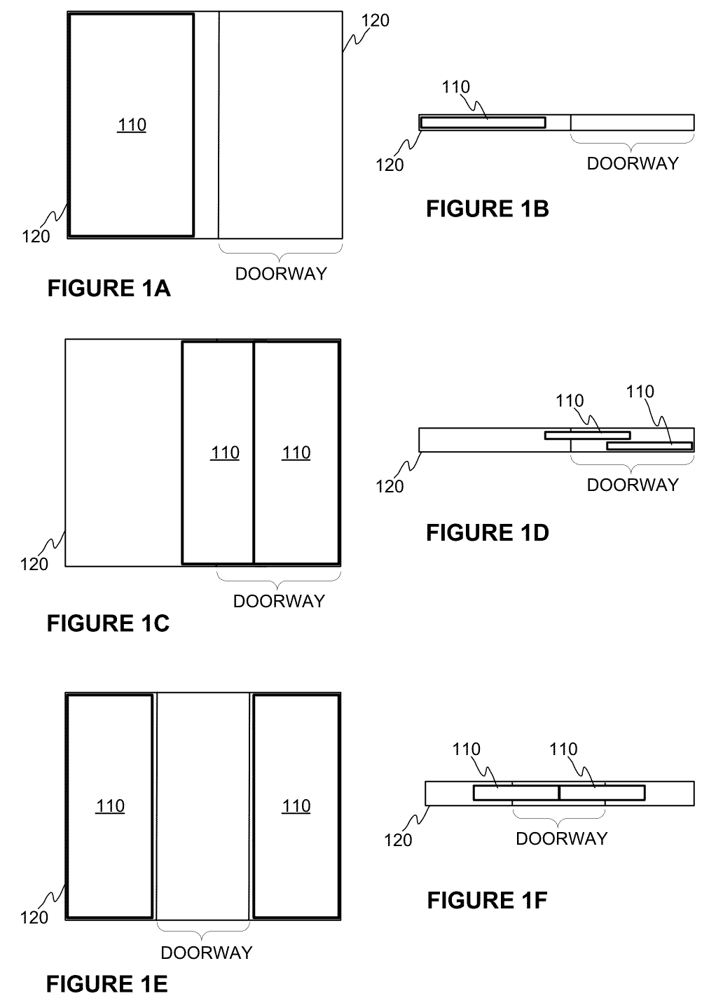

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

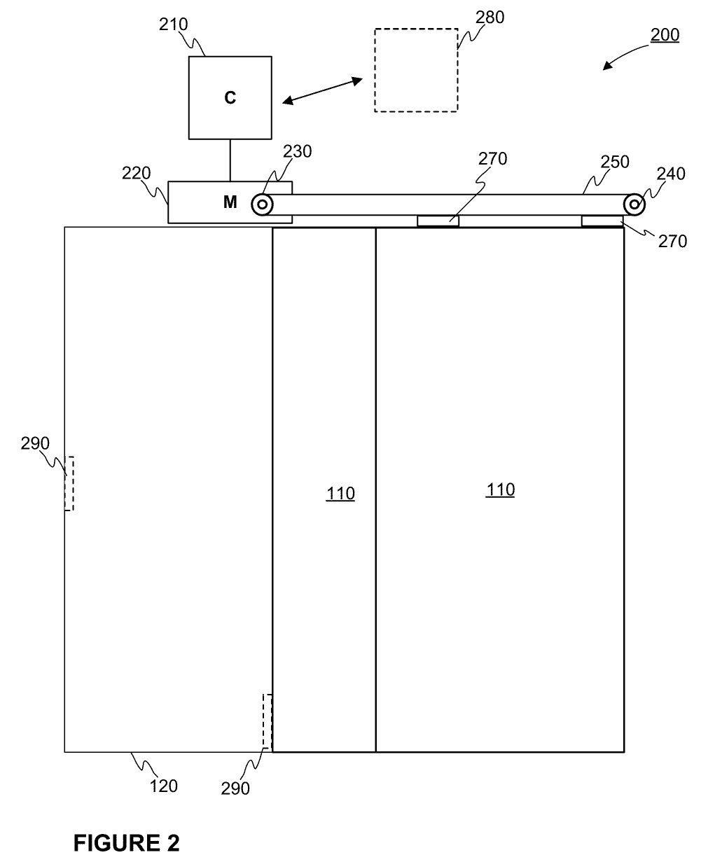

Generally speaking, the present invention is described below with a number of examples wherein the invention is directed to a condition evaluation of an automatic door through an evaluation of a condition of a door drive belt of the automatic door. The automatic door shall herein be understood to cover doors that are operated with a motor wherein a transmission mechanism comprises the door drive belt. Furthermore, the automatic door in the context of the present invention is a sliding door type automatic door. FIG. 2 illustrates schematically an example of an automatic sliding door 200 applicable e.g. in elevators wherein the automatic door 200, and specifically the door leaf/leaves 110 is arranged to travel in a travel path defined by a door frame 120 in at least in travel directions. The automatic door 200 may comprise a door controller 210 that is configured to perform a control of the automatic door, e.g. in a form of control signals. The control of the automatic door 200 may e.g. refer to an operation causing opening and closing of the door. More specifically, the door controller 210 may be arranged to control an electric motor 220 of the automatic door 200 and the force generated by the electric motor 220 is brought to a drive pulley 230 and in response to that the rotation of the drive pulley 230 starts moving the door drive belt 250 that is tensioned between the drive pulley 230 and an idler pulley 240 as a closed belt (cf. implemented as a continuous loop). Since at least one door leaf 110 is coupled to the door drive belt 250 with so-called hanger plates 270 by also applying fixing means, like clamps or fasteners, the at least one door leaf 110 travels along with the linear motion of the door drive belt 250. For avoidance of doubt the automatic door 200 as shown in FIG. 2 comprises two door leaves 110 and their synchronous operation may e.g. be achieved by applying any known coupling technique, such as a door coupler, wherein the door leaf 110 driven with the electric motor 220 is arranged to couple the other door leaf 110 during the movement. For avoidance of doubt it is worthwhile to mention that the automatic door mechanism comprise further entities as well as arrangements, such as the automatic door may be provided with a rail along which it is arranged to travel in order to guide it in its travel path. This kind of approach may require use of support wheels even if the transmission mechanism is the one based on the door drive belt 250 as described in the foregoing description. FIG. 2 also illustrates a computing entity 280 communicatively connected to the door controller 210. Alternatively or in addition, the computing entity 280 may be communicatively connected to other entities, such as the electric motor 220 and any entities therein, such as to the encoder of the door motor 220, to receive data descriptive of the movement of the automatic door 200. The communicative connection may be implemented with wireless or wired communication technology.

In accordance with at least some embodiments of the invention the automatic door 200, i.e. the automatic door system, may further comprise at least one elastic element 290. The elastic element 290 may e.g. be mounted to one of the following: the door frame 120; the at least one door leaf 110 as shown in a non-limiting manner in FIG. 2. Further details and embodiments with respect to the elastic element and its role in the context of the present invention are provided in the forthcoming description.

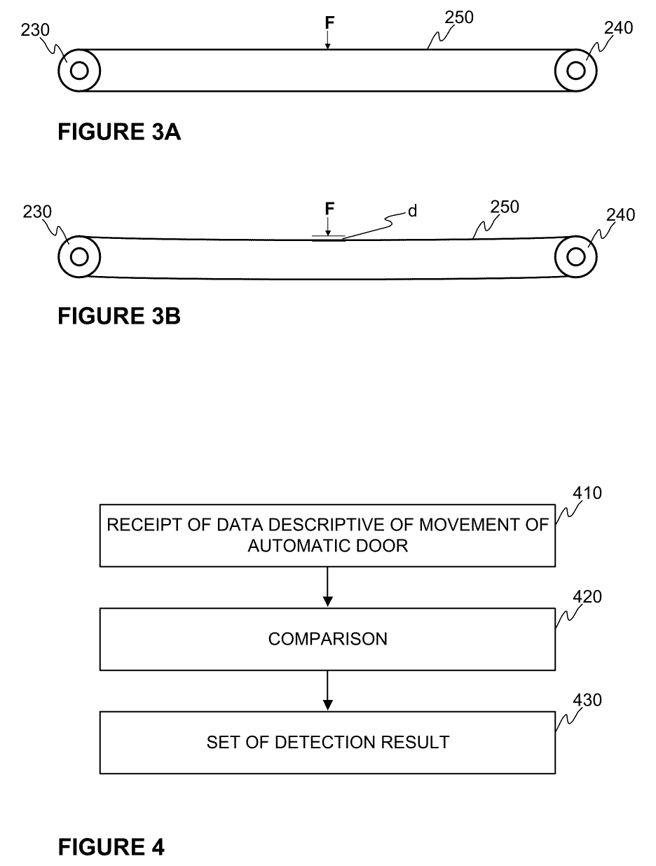

FIGS. 3A and 3B provide schematically at least some insight to a tension aspect of the door drive belt 250. Namely, FIG. 3A illustrates a situation in which the tension of the door drive belt 250 between the drive pulley 230 and the idler pulley 240 is acceptable, i.e. within predefined limits. A testing of the tension may be performed by providing a force F against the belt 250 and by measuring a deviation of the belt 250 from the optimal position due to the force. FIG. 3B illustrates schematically a situation that the door drive belt 250 is loose between the pulleys 230, 240 e.g. due to wearing and in response to a provision of the force F to the belt 250, it causes a deviation d from the optimal position. The FIGS. 3A and 3B are primarily illustrated for providing understanding on the meaning of the loose belt 250.

As is commonly known the automatic door 200, and specifically the door leaf 110 or leaves 110, is operating so that it either allows or blocks the doorway for going. In other words, the door leaf 110 or leaves 110 are controlled to close the doorway upon a need. Thus, the automatic door 200 comprises an open state and a closed state. In the closed state the automatic door 200 is controlled to drive the door leaf 110, or leaves 110, so that at least one door leaf 110 reaches an extreme position defined e.g. by the door frame 120 or similar so as to close the doorway. Correspondingly, in the open state the door leaf 110, or leaves 110, are driven to the other extreme position to open the doorway for going.

Next, at least some aspects of the present invention are described by referring to FIG. 4 schematically illustrating an example of a method for evaluating a condition of a door drive belt 250 of an automatic door 200. As described, the automatic door 200 is operated by controlling a door motor 220 that is operatively coupled to a door leaf 110, or door leaves, over a transmission system comprising the door drive belt 250. The method may be performed by a computing system which may correspond to the door controller 210, the computing entity 280 or any other computing entity communicatively connected to entities to obtain pieces of data in order to perform the method as described in the forthcoming description.

In step 410 of the method as depicted in FIG. 4 the computing system is arranged to receive 410 data descriptive of a movement of the automatic door. The data may e.g. be received from the door motor 220, e.g. from an encoder therefrom. The encoder of the door motor 220 translates a movement of the automatic door 200, or the door leave(s), into electrical signals descriptive of one or more movement-related parameters. In other words, the data descriptive of the movement of the automatic door 200 is such that a speed or a time related aspects of the automatic door 200 may be determined on the basis of the data. In other words, the data received 410 may either directly represent the speed and/or the time of movement or at least the speed may be derivable therefrom indirectly. For the purpose of the present invention a behavior of the automatic door 200 at an extreme position, i.e. the fully open state or the fully closed state, is under interest especially when a driving force of the door motor 220 is reduced.

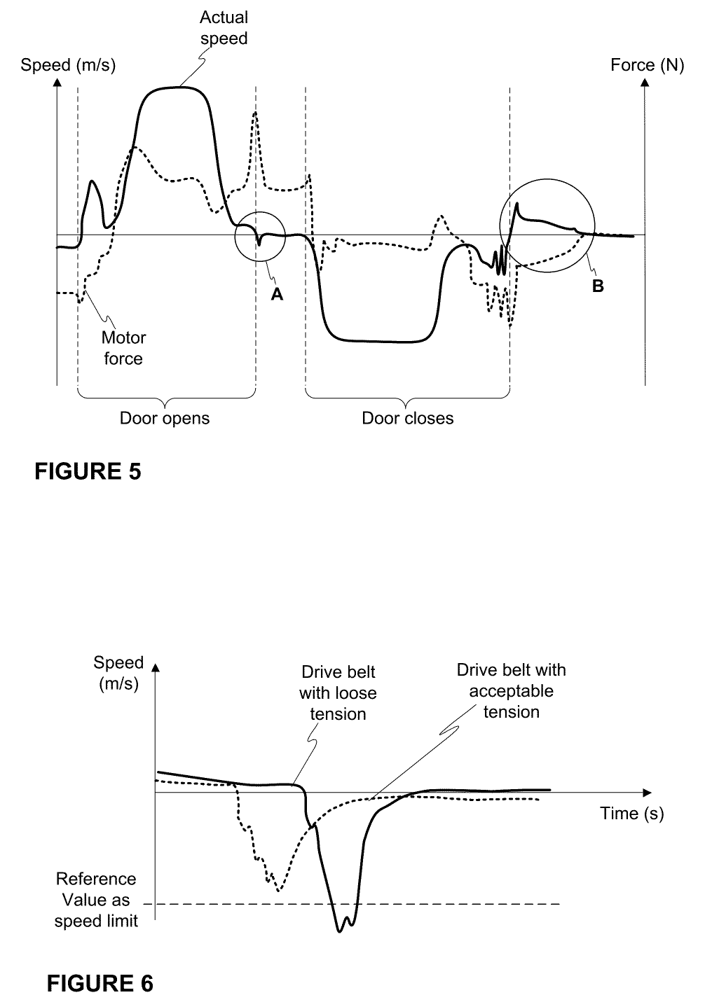

In order to increase understanding with respect to this, and also other aspects of the invention, it is hereby referred to FIG. 5 schematically illustrating curves of a force of a door motor 220 and an actual speed of the automatic door in relation to time during an operating cycle of the automatic door 200. As depicted in FIG. 5, the operating cycle starts from a situation that the automatic door 200 is in a fully closed state and it is first instructed to open and then to close. To instruct the automatic door to operate so one or more control signals are generated to the door motor 220, i.e. an electric motor. The control signal may e.g. carry data defining a speed curve (not shown in FIG. 5) to the door motor 220 so as to set target speed for the door motor 220 in various instants of time during the operating cycle. In order to follow the targeted speeds defined by the speed curve the door motor 220 generates a motor force as shown as a non-limiting example in FIG. 5. Since there is a deviation in the actual speed of the automatic door and the targeted speed, the actual speed is measured, or determined, e.g. from the encoder of the electric motor as already mentioned. As regards to the opening phase of the automatic door it may be derived from FIG. 5 that the motor force starts to increase causing an increase in the actual speed of the automatic door 200. A portion of the travel during the opening may be driven substantially at a constant speed and when the automatic door start reaching the extreme end the motor force is accordingly controlled and when the moving part of the door structure, i.e. the at least one door leaf 110, reaches the extreme end, or position, such as hitting the door frame 120, the actual speed of the automatic door 200 reaches zero. For understanding the implementation as shown in FIG. 5 it is worthwhile to mention that the motor force is increased when the door leaf 110 is reaching the extreme end in order to confirm that the door gets fully open. This is naturally dependent on the implementation of the operating curve, the thus the generation of the motor force. Correspondingly, the closing phase of the automatic door 200 again starts by controlling the door motor 220 to generate a motor force causing the closing of the automatic door 200. The actual speed pattern of the automatic door 200 during the closing corresponds more or less to the pattern during the opening (e.g. the speed increase, speed decrease, constant speed). In FIG. 5 the extreme positions of the automatic door 200 are marked with circles denoted with A and B which are under interest for the purpose of the present invention.

Namely, as mentioned the receipt 410 of data descriptive of the movement of the automatic door 200 shall at least comprise the data descriptive of the movement of the automatic door 200 at the extreme end area and/or close to it, e.g. defined by a predefined distance, or range, from the extreme ends. The extreme ends and reaching of them may be defined in various manner, such as on a basis of a position information of the automatic door 200, on a basis of timing information of the automatic door 200 (cf. travel time in opening/closing directions), etc. In any case, the computing system configured to perform the method may be configured to compare 420 the data descriptive of the movement of the automatic door 200 to reference data wherein the reference data may define one or more reference values for the parameter under interest or a shape of at least portion of a curve defined by the data descriptive of the movement of the automatic door 200. Hence, the reference data may e.g. define at least one value, such as a speed limit, or derivative therefrom, such as a rate at which the speed changes with time (an acceleration value), within a predefined movement window, i.e. occurring with the extreme end area(s) as described. Alternative or in addition, the reference data may define a reference value defining a time limit, or range, for a predefined event. It may also be that the reference data comprises dedicated reference speed limits and/or time limits in relation to a movement for the extreme ends separately, i.e. at least one first reference value for the extreme end in the opening direction and at least one second reference value for the extreme end in the closing direction (i.e. for the areas highlighted with the circles denoted with A and B in FIG. 5). The reference data may also be defined as a graph, such as a curve, in e.g. a speed/time scale that e.g. represents a shape of the curve when the door operates within proper limits. Naturally, the reference data may define one or more shapes of the curve that are non-acceptable, i.e. that represent improper operation of the automatic door 200.

As can be seen from the actual speed curve representing the movement of the automatic door 200 in FIG. 5 the automatic door 200, i.e. the at least one leaf 110 of the automatic door 200, moves in response to that the motor force is reduced, or even fully removed. The movement may be considered as a sort of rebounding effect that occurs both in the open end as well as at the closing end at least in part due to an elasticity of the counterpart, such as the door frame 120, the respective edge surface of the leaf 110 of the automatic door 200 hits.

As mentioned in the foregoing description, the condition of the door drive belt 250 may be evaluated through the comparison 420 of at least part of the data descriptive of the movement of the automatic door 200 to reference data. Aspects in relation to this is now described by referring to FIG. 6 schematically illustrating, as an example, a curve of the actual speed of the automatic door 200 in a situation that the tension of the door drive belt 250 is acceptable and a curve of the actual speed of the automatic door 200 in a situation that the tension of the door drive belt 250 is loose when the door is opening. In other words, FIG. 6 depicts schematically events for the mentioned situation at the extreme end of the automatic door 200 in the closing direction. For avoidance of doubt, it may be considered that the tension of the door drive belt 250 is acceptable when the tension is within a nominal range e.g. defined by a technical specification of the automatic door 200 in question. FIG. 6 also depicts a reference value for the actual speed to be applied in the comparison 420 to evaluate the condition of the door drive belt 250 through the evaluation of the tension of the door drive belt 250. As can be seen in the shown example the reference value is defined in terms of the speed value to decide if the tension of the drive door belt 250 is acceptable of not. In other words, the idea is to conclude that the tension is too loose if the absolute value of the actual speed of the automatic door 200, i.e. the maximum speed, measured e.g. on the basis of the data received from the encoder of the door motor 220 exceeds the reference value expressed as an absolute value. The approach is possible because a maximum value of the speed increases in response to that the tension of the drive belt 250 looses.

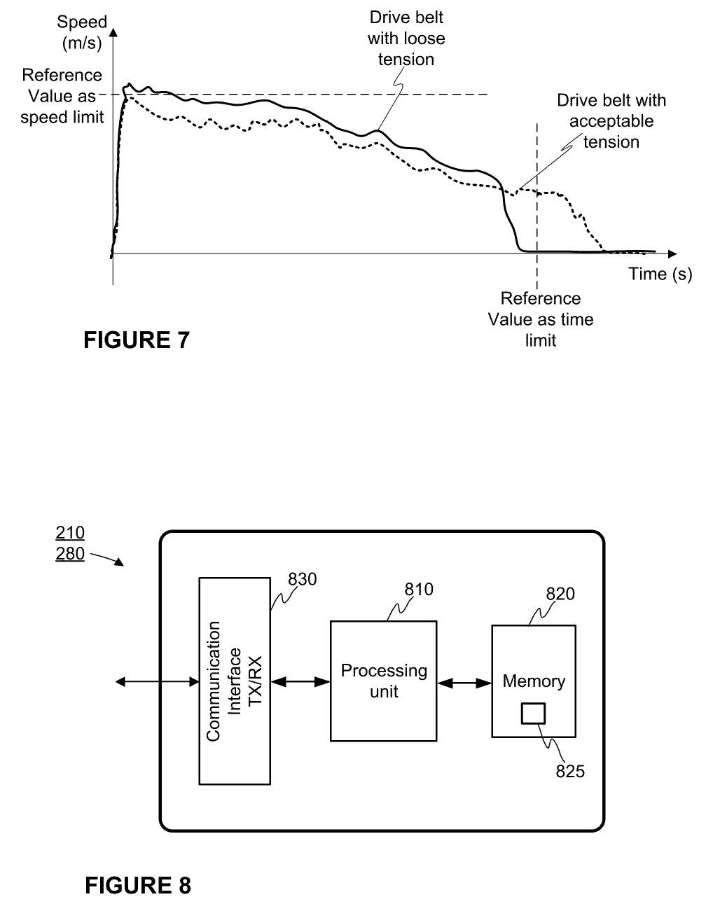

Correspondingly, FIG. 7 illustrates schematically as an example, a curve of the actual speed of the automatic door 200 in a situation that the tension of the door drive belt 250 is acceptable and a curve of the actual speed of the automatic door 200 in a situation that the tension of the door drive belt 250 is loose when the automatic door is closing. In other words, FIG. 7 depicts schematically events for the mentioned situation at the extreme end of the automatic door 200 in the closing direction. Specifically speaking, the curves shown in FIG. 7 illustrate schematically a movement of the automatic door 200 in an implementation where a plurality of door leaves 110 are coupled together with a coupler and the generation of the motor force, i.e. torque, is reduced or removed when the automatic door 200 has reached the closed position. This leads to a coupler relaxation in a main spring compression coupler implementation. As derivable from FIG. 7 the relax movement time is comparable to the door drive belt 250 tension. With loose door drive belt 250, the relaxation occurs faster than with the door drive belt 250 having an acceptable tension (cf. defined e.g. as a nominal range as described) as the loose door drive belt 250 allows more free movement during start of the relaxation. Either a maximum relaxation speed (actual speed) or a relaxation time may be determined from a relaxation period (cf. the time window marked with the circle denoted with B in FIG. 5) and at least one of these may be compared to a respective reference value as schematically illustrated in FIG. 7 (reference value defined as speed value and/or reference value as time value). Here again, the evaluation of condition of the door drive belt 250 is based on a detection if an absolute value of the actual speed exceeds the reference value set for the speed in a situation that the motor force of the door motor is reduced when the automatic door 200 is closed. The reference value for the speed is defined so that the loose tension of the door drive belt 250 may be detected. Alternatively or in addition, a reference time value may be defined for reaching the relax position of the automatic door 200, i.e. it is fully stopped and it may be applied so that in case that the door 200 reaches the relaxed position prior to the reference value, it may be concluded that the door drive belt 200 has a loose tension whereas if the reference value is exceeded, it may be concluded that the tension of the belt 250 is in a nominal range, i.e. acceptable.

The situation as depicted in FIG. 7 is described above in a context that the automatic door system comprises a coupler and it causes a relaxation phenomenon as described. However, the fundamental principle wherein the described reference values are applied to in the described manner also applies for an implementation of the automatic door 200 without the coupler and e.g. only one door leaf 110 is caused to close and reach the extreme end. In other words, also in such a situation the movement of the automatic door 200 may be considered as a sort of rebounding effect that occurs in the closing end at least in part due to an elasticity of the counterpart, such as the door frame 120, the respective edge of the leaf 110 of the automatic door 200 is hitting.

In accordance with the embodiment of the method as illustrated in FIG. 4 a detection result to express one of the following: i) the condition of the door drive belt is proper, ii) the condition of the door drive belt is improper is set 430 in accordance with a comparison between the at least part of the data descriptive of the movement of the automatic door and the reference data. In other words, in case the comparison indicates that the tension of the door drive belt 250 is loose, the detection result is set to express that the condition of the door drive belt 250 is improper. Correspondingly, if it is detected on the basis of the comparison 420 that the tension of the door drive belt 250 is acceptable, i.e. e.g. within the nominal range, the detection result may be set to express that the condition of the door drive belt 250 is proper. The method may further comprise a step of generating a request to maintain the door drive belt 250 in response to that the condition of the door drive belt 250 is set to be improper. The request may be generated by the computing system 210, 280 as a signal, such as a message, to a maintenance management system of the automatic door 200 so as to achieve a maintenance of the door 200. Since the detection result expressing the improper operation of the automatic door 200 is determined in the described manner, the maintenance personnel understands, and knows, that the reason for the improper operation is the loose tension of the door drive belt 250 and it needs to be adjusted/replaced.

For avoidance of doubt it is worthwhile to mention that the reference data defined by one or more reference values descriptive of the predefined characteristic in relation to the movement of one or more entities of the automatic door 200, such as the door leaf 110, may represent speed related value or time related value as described. It may also be arranged that reference data is defined for a plurality of characteristics and a plurality of comparisons 420 are executed between the received data comprising a number of data values of the respective characteristics and the respective fence data. In accordance with an embodiment of the invention the reference data and the data descriptive of the movement of the data are expressed as a curves, or portions of the curves, wherein the shape of the curve is evaluated in the comparison 420. In accordance with the present invention the computing system implementing the method may be configured to perform at least some of the steps of the method, such as the comparison step 420, by applying so-called rule-based approach or by applying a machine-learning (ML) model in the task. In the rule-based approach the method is at least in part implemented so that the detection result is generated by applying one or more pre-defined rules in the process (cf. e.g. if a measurement value is larger/smaller than a respective reference value in the comparison step). The ML model approach is based on an applicable machine-learning model that is trained to perform a predefined task, such as the comparison step 420 of the method. Hence, the trained ML model may receive one or more data values descriptive of the movement of the automatic door 100 and evaluate the received data as it is trained to do and to generate a detection result accordingly. For example, the ML model may be trained to evaluate curve shapes, or at least portions of them, so as to detect if the drive belt is loose or not. In such an approach the reference data may be used as training dataset for the ML model to train the ML model to operate in a correct manner.

The invention as described herein is based on a detection of the movement of the automatic door 200 at an extreme position, i.e. at fully open state or at fully closed state, in response to that the motor force, i.e. torque, is reduced. As described, the rebound effect as described is achieved when the automatic door 200 is in contact with a counterpart, such as a door frame 120, towards which the door leaf 110 is driven. The door structure and/or the counterpart has an elasticity that causes the rebound effect when the motor force is reduced and by measuring the rebound effect in the described manner and evaluating the data as described, the condition of the door drive belt 250 may be evaluated in the manner as described and the detection result may be generated. In order to enhance the rebounding effect it may be arranged that at least one elastic element made of an elastic material is introduced so that it resides, as a kind of buffer, between the edge surface of the door leaf 110 facing towards the counterpart and the counterpart, such as the door frame 120. In other words, the at least one elastic element may be mounted either to the door or to the counterpart. Now, when the door is driven to the respective end, the elastic buffer gets squeezed and when the motor force is reduced, or cut fully, an enhanced rebounding effect is achieved due to a deformation of the shape of the buffer. As a result, the measured values, such as the actual speed value, is larger and as a result a decision-making if the door drive belt 250 is loose or not may be made in a more reliable manner. As some non-limiting examples of the elastic element a spring, a rubber piece, an air filled element may be mentioned. As said, the elastic element may reside between the door leaf 110 and the counterpart, but the effect of the elastic element may also be achieved with a spring compression of a door coupler that a relaxation of the door coupler causes the spring to return to its relaxed state so as to cause the rebounding effect to the door leaf 110 if any.

Hence, as a conclusion of the foregoing description it is worthwhile to mention that in order to perform the method to evaluate a condition of a door drive belt 250 of an automatic door 200 data descriptive of a movement of the automatic door, such as a movement of at least one door leaf 110, is to be gathered in response to that a driving force of a door motor 220 is reduced, or totally removed. In accordance with the present invention this is performed when the automatic door 200 is driven to an extreme position, i.e. the door is either fully closed state or fully open state. Thus, the triggering event for the gathering of data may be a detection that the driving force of the door motor 220 is reduced e.g. in a stepwise manner or otherwise. However, it is also possible that the data descriptive of the movement of the automatic door 200 is gathered over the full travel path, but the analysis may, according to an embodiment, be performed to the portion that represents data generated in response to that the driving force of the door motor 220 is controlled as described.

An example of a computing system, such as a door controller 210 or a further computing entity 280, configurable to implement at least a part of the method is schematically illustrated in FIG. 8. For sake of clarity, it is worthwhile to mention that the block diagram of FIG. 8 depicts some components of an apparatus that may be employed to implement a functionality of the computing system. The computing system of FIG. 8 comprises a processor 810 and a memory 820. The memory 820 may store data, such as pieces of data as described, but also computer program code 825 causing the operation of the computing system in the described manner. In at least some embodiments, the computing system may further comprise a communication interface 830, such as a wireless communication interface or a communication interface for wired communication, or both to communicate with other entities as described. The communication interface 830 may thus comprise one or more modems, antennas, and any other hardware and software for enabling an execution of the communication e.g. under control of the processor 810. Furthermore, I/O (input/output) components may be arranged, together with the processor 810 and a portion of the computer program code 825, to provide a user interface for receiving input from a user, such as from a technician, and other sources and/or to provide output to the user of the apparatus as described. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information between the components.

The memory 820 and at least a portion of the computer program code 825 stored therein may further be arranged, with the processor 810, to cause the computing system to execute the data processing engine and, thus, to perform at least a portion of a method as is described herein. The processor 810 may be configured to read from and write to the memory 820. Although the processor 810 is depicted as a respective single component, it may be implemented as respective one or more separate processing components. Similarly, although the memory 820 is depicted as a respective single component, it may be implemented as respective one or more separate components, some, or all of which may be integrated / removable and / or may provide permanent / semi-permanent / dynamic / cached storage.

The computer program code 825 may comprise computer-executable instructions that implement functions that correspond to steps implemented in the method when loaded into the processor 810 of the respective entity. As an example, the computer program code 825 may include a computer program consisting of one or more sequences of one or more instructions. The processor 810 is able to load and execute the computer program by reading the one or more sequences of one or more instructions included therein from the memory 820. The one or more sequences of one or more instructions may be configured to, when executed by the processor 810, cause the computing system, such as the door controller 210 or a further computing entity 280, to perform a method as described. Hence, the computing system may comprise at least one processor 810 and at least one memory 820 including the computer program code 825 for one or more programs, the at least one memory 820 and the computer program code 825 configured to, with the at least one processor 810, cause the computing system to perform the method. For avoidance of doubt it is worthwhile to mention that the machine-learning model trained for the task as described may be part of the computer program code 825 stored in the memory 820.

The computer program code 825, or at least some portion of it, may be provided e.g. a computer program product comprising at least one computer-readable non-transitory medium having the computer program code 825 stored thereon, which computer program code 825, when executed by the processor 810 causes the computing system to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 825 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the computing system may also be implemented with a plurality of apparatuses, such as the one schematically illustrated in FIG. 8, as a distributed computing environment. For example, one of the apparatuses may be communicatively connected with the other apparatuses, and e.g. share the data of the method, to cause another apparatus to perform at least one other portion of the method. As a result, the method performed in the distributed computing environment generates the detection result as described. The functionalities of the computing entity as described may also be integrated to an entity configured also to perform other operations. According to a non-limiting example a first apparatus may be the door controller 210 and a second apparatus may be the computing entity 280 as shown in FIG. 2.

The above-described solution for evaluating a condition of a door drive belt 250 of an automatic door 200 also enables the evaluation through a development of the operation of the door by gathering and storing data descriptive of a movement of the automatic door 200 over a predefined period of time. In other words, it is possible to form a database and evaluate the development of the condition of the door drive belt 250 by comparing the data descriptive of the movement of the automatic door 200 obtained various instants of time. In some approaches, the reference data may be formed from one or more earlier pieces of data descriptive of the movement of the automatic door 200. For example, the reference data may be formed by applying statistical methods to the gathered data, such as by calculating an average from a plurality of earlier data values.

The invention as described with a number of embodiments and examples in the foregoing description provides a tool to efficiently detect a malfunctioning of the automatic door 200 due to that the tension of the door drive belt 250 is not optimal. Moreover, it enables reacting to a development of the condition of the door belt 250 in an improved manner and, thus, schedule a maintenance of the door drive belt 250.

The specific examples provided in the description given above should not be construed as limiting the applicability and/or the interpretation of the appended claims. Lists and groups of examples provided in the description given above are not exhaustive unless otherwise explicitly stated.

What is claimed is:

1. A method for evaluating a condition of a door drive belt (250) of an automatic door (200), wherein the automatic door (200) is operated by controlling a door motor (220) operatively coupled to a door leaf (110) over the door drive belt (250), the method, performed by a computing system comprises:
receiving (410) data descriptive of a movement of the automatic door (200) in response to a reduction of a driving force of the door motor (220) at an extreme position of the automatic door (200) in its travel path,
comparing (420) at least part of the data descriptive of the movement of the automatic door (200) to reference data, and
setting (430), in accordance with a comparison between the at least part of the data descriptive of the movement of the automatic door (200) and the reference data, a detection result to express one of the following: i)]] the condition of the door drive belt (250) is proper, ii)]] the condition of the door drive belt (205) is improper.

2. The method according to claim 1, wherein the data descriptive of the movement of the automatic door (200) is received from an encoder of the door motor .

3. The method according to claim 1, wherein the reference data is descriptive of at least one of the following: speed related limit; time related limit; a shape of a curve representing the movement of the automatic door (200).

4. The method according to claim 1, the method further comprises:
generating a request to maintain the door drive belt (250) in response to that the condition of the door drive belt (250) is set to be not proper.

5. A computing system for evaluating a condition of a door drive belt (250) of an automatic door (200), wherein the automatic door (200) is operated by controlling a door motor (220) operatively coupled to a door leaf (110) over the door drive belt (250), the computing system (210,280) is configured to:
receive (410) data descriptive of a movement of the automatic door (200) in response to a reduction of a driving force of the door motor (220) in its travel path,
compare (420) at least part of the data descriptive of the movement of the automatic door (200) to reference data, and
set (430), in accordance with a comparison between the at least part of the data descriptive of the movement of the automatic door (200) and the refernce data, a detection result to express one of the following: i) the condition of the door drive belt (250) is proper, ii) the condition of the door drive belt (250) is improper.

6. The computing system according to claim 5, wherein the computing system is configured to receive the data descriptive of the movement of the automatic door (200) from an encoder of the door motor (220).

7. The computing system according to any of the preceding claim 5, wherein the computing system is configured to apply as the reference data that is descriptive of at least one of the following: speed related limit; time related limit; a shape of a curve representing the movement of the automatic door (200).

8. The computing system according to any of the preceding claim 5, the computing system is further configured to:
generate a request to maintain the door drive belt (250) in response to that the condition of the door drive belt (250) is set to be not proper.

9. An automatic door (200), comprising:
at least one door leaf (110),
a door frame (120) defining a travel path of the at least one door leaf (110), and
a computing system (210, 280) according to claim 5

10. The automatic door (200) according to claim 9, wherein the automatic door (200) further comprises at least one elastic element mounted between the door frame (120) and the at least one door leaf (110) .

11. The automatic door (200) according to claim 10, wherein the at least one elastic element is mounted to one of the following: the door frame (120); the at least one door leaf (110).

12. The automatic door (200) according to claim 10, wherein the at least one elastic element has an elasticity allowing a squeeze of the elastic element in response to driving the at least one door leaf (110) against the door frame (120).

13. The automatic door (200) according to claim 10 wherein the at least one elastic element is at least one of the following: a spring; a rubber piece; an air filled element.

14. The automatic door (200) according to claim 9 wherein the automatic door is an elevator door.

15. A non-transitory computer readable medium storing a computer program comprising instructions to cause acomputing system to execute the steps of the method of claim 1.

16. The method according to claim 2, wherein the reference data is descriptive of at least one of the following: speed related limit; time related limit; a shape of a curve representing the movement of the automatic door.

17. The method according to claim 2, the method further comprises:generating a request to maintain the door drive belt in response to that the condition of the door drive belt is set to be not proper.

18. The method according to claim 3, the method further comprises:generating a request to maintain the door drive belt in response to that the condition of the door drive belt is set to be not proper.

19. The computing system according to claim 6, wherein the computing system is configured to apply as the reference data that is descriptive of at least one of the following: speed related limit; time related limit; a shape of a curve representing the movement of the automatic door.

20. The computing system according to claim 6, the computing system is further configured to:generate a request to maintain the door drive belt in response to that the condition of the door drive belt is set to be not proper.
